(19) United States
(12) Patent Application Publication
(10) Pub. No.: US 2016/0059231 A1
(43) Pub. Date: Mar. 3, 2016

(54) BIOLOGICAL SAMPLE COLLECTION CONTAINER

(71) Applicant: Douglas Jay Wilson, San Diego, CA (US)

(72) Inventor: Douglas Jay Wilson, San Diego, CA (US)

(21) Appl. No.: 14/814,377

(22) Filed: Jul. 30, 2015

Related U.S. Application Data
(60) Provisional application No. 62/041,942, filed on Aug. 26, 2014.

(51) Int. Cl. B01L 3/00; B65B 7/28

(52) U.S. Cl. CPC B01L 3/508; B65B 7/28; B01L 2200/0615; B01L 2300/042; B01L 2300/0858

(57) ABSTRACT

A hollow container for collecting and containing biological samples has a base, a top, one or more walls extending upward from the base to the top, and a lid that engages with the base or the top. Prior to use, the top is sealed using a cover to prevent infiltration of contaminants into the interior of the container. Prior to, and/or during, use the lid is removably engaged with the base to prevent contamination of the interior of the lid. A method of using the container begins with removing the cover from the top of the container. Then, a sample is deposited into the container. Next, the lid is removed from the base of the container. Finally, the lid is engaged with the top to releasably seal the container and prevent contamination of the sample prior to analysis.

### CROSS-REFERENCE TO RELATED APPLICATION

The present application claims priority to U.S. Provisional Patent Application No. 62/041,942 filed on Aug. 26, 2014, entitled “URINE COLLECTION CONTAINER COMPATIBLE TO A WOMAN'S BODY PROVIDING FOR SANITARY USE AND AVOIDS CONTAMINATION”, the entire disclosure of which is incorporated by reference herein.

### BACKGROUND OF THE INVENTION

1. Field of Invention

This invention relates to containers for collecting and containing biological samples.

2. Description of Related Art

Biological matter, such as urine and feces, is routinely collected and tested for diagnostic and/or other purposes. During the collection process, a sample is placed in a container, which is then sealed with a lid in an effort to prevent contamination of the sample prior to analyzing the sample.

Currently, biological sample collection containers have a cylindrical or frustoconical shape. While these shapes provide ease of sample removal from the container, they allow fluids, such as urine, to be splashed out of the container during the collection process. Additionally, the shape allows a liquid sample to completely evacuate the container in the event the container is tipped on its side prior to sealing the container. This could pose a major inconvenience in situations in which the container is overturned after the patient has completely emptied his/her bladder, necessitating a new appointment for sampling.

In addition to the foregoing, the removable lids of current collection containers pose a threat of sample contamination and possible misdiagnosis and/or treatment of the patient. For example, in using the current containers, once removed, the lids are generally set down on non-sterile, contaminated surface, such as a toilet, sink or countertop. Studies have shown that these types of surfaces harvest tremendous amounts of bacteria. Additionally, the handling of the lid creates the opportunity for a patient to inadvertently contaminate the interior of the lid by touching it with his/her finger(s). By touching the interior of the lid or placing the lid on the contaminated surface, bacteria is able to transfer from the patient's hand or the surface to the interior of the lid, which will ultimately be transferred to the interior of the container and the sample being collected. The introduction of bacteria creates the potential for a medically flawed analysis of the sample.

Based on the foregoing, there is a need in the art for a biological sample collection container that prevents splash-out of fluids being collected and total loss of liquid samples in the event of an overturn of the container. Additionally, there is a need for a container that provides a sterile lid management system to prevent inadvertent contamination of samples.

### SUMMARY OF THE INVENTION

A biological sample collection container has a base, a top, one or more walls extending upward from the base to the top, and a lid that sealingly engages with the base or the top. The base and the one or more walls define a hollow central portion, wherein the top defines an aperture that extends into the central portion.

In an embodiment, the outer surfaces of the top and the base are circumferentially threaded, and an inner surface of the lid that corresponds to the lid's inner circumference is correspondingly threaded, allowing the lid to screw onto the top or the base.

In an embodiment, a recessed cavity extends upward into the base. The inner surfaces of the top and the base are circumferentially threaded, and an outer surface of the lid that corresponds to an outer circumference of the lid is correspondingly threaded, allowing the lid to screw into the top or the base. In an alternative embodiment, the lid is made of a compressible material, or, alternatively, a compressible material is adhered to an outer surface of the lid, allowing the lid, when pressed into the base or top, to sealingly engage with an inner surface of either the base or the top.

In an embodiment, a compressible material is adhered to an inner surface of the lid, allowing the lid, when pressed onto the base or top, to sealingly engage with an outer surface of either the base or the top.

In an embodiment, the walls extend outwardly from a perimeter of the base and the top.

In alternative embodiments, the container is capable of being any shape, including, but not limited to, cylindrical, cubical, frustoconical, or bulbous.

In an embodiment, a disposable cover is adhered to the top during the manufacturing process. When ready for use, the cover is removed from the top to expose the aperture.

In an embodiment, a method of using the container includes the steps of removing the cover from the top of the container, depositing a sample into the container, removing the lid from the base of the container, and engaging the lid with the top to releasably seal the container.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 is a side elevation view of a biological sample collection container, according to an embodiment of the present invention;

FIG. 2 is a side elevation view of the biological sample collection container, according to an embodiment of the present invention;

FIG. 3 is a side elevation view of the biological sample collection container, according to an embodiment of the present invention.

### DETAILED DESCRIPTION OF PREFERRED EMBODIMENTS

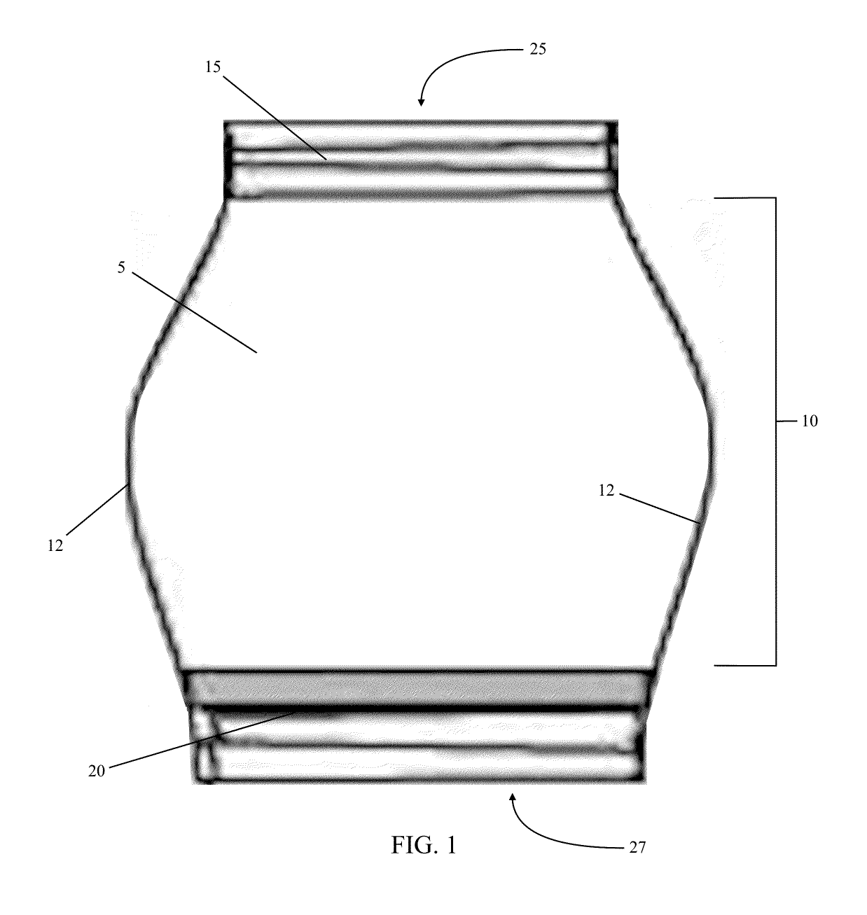

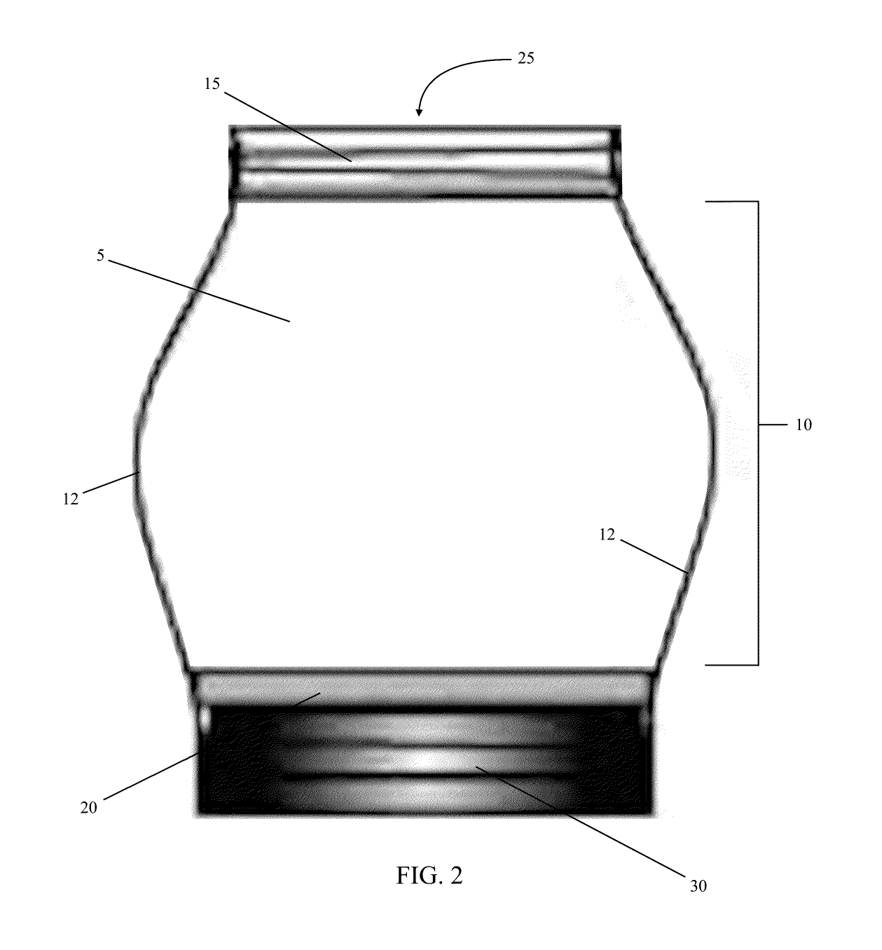

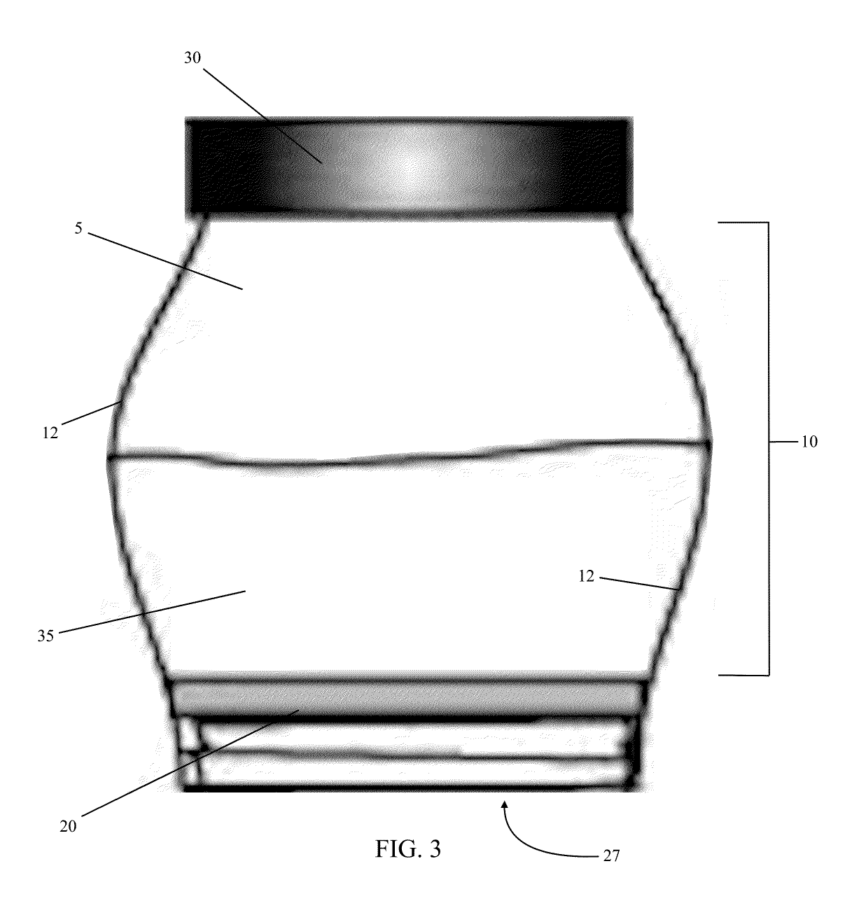

Preferred embodiments of the present invention and their advantages may be understood by referring to FIGS. 1-3 wherein like reference numerals refer to like elements.

With reference to FIGS. 1-3, in a preferred embodiment, the biological sample collection container 5 has a hollow central portion 10 for containing a sample 35. The central portion 10 is defined by one or more walls 12 and a base 20. A top 15 extends upward from the central portion 10, and defines an aperture that extends into the central portion 10. The base 20 extends downward from the central portion 10 and seals the lower end of the central portion to prevent passage of matter into or out of the central portion 10. In an embodiment, a recessed cavity 27 extends upward into the base 20 and is separated from the central portion 10 by an upper surface of the base 20. A lid 30 is configured to releasably and sealingly engage with the top 15 or the base 20.

In a preferred embodiment, as exemplified in FIGS. 1-3, the container 5 has a bulbous shape, i.e. the central portion 10 of the container is wider than, and tapers inward to connect to, both the top 15 and the base 20. However, one reasonably skilled in the art would understand and appreciate that the container 5 could be embodied in alternative shapes, such as cylindrical, cubical, or frustoconical, without deviating from the scope of the present invention.

In an embodiment, the interior circumference of the lid 30 is larger than the outer circumferences of the base 20 and the top 15. In an alternative embodiment, the exterior circumference of the lid 30 is smaller than the inner circumferences of the base 20 and the top 15.

In an embodiment, an interior and/or exterior surface of the top 15 and the base 20 is/are threaded circumferentially, and an interior and/or exterior surface of the lid 30 that corresponds to the lid's inner and/or outer circumference is correspondingly threaded to allow the lid 30 to be matingly threaded onto and/or into the top 15 or base 20. In another embodiment, the lid 30 is constructed of a compressible material (not shown), such as rubber, silicone, foam, or cork, or, alternatively, a compressible material is adhered to an inner and/or outer surface of the lid 30. As the lid 30 is placed into and/or onto either the base 20 or the top 15, the compressible material sealingly engages with the outer and/or inner surface(s) of the base 20 or the lid 15, and is held in place using a friction fit. Although a threaded closure and a friction fit closure have been disclosed, it would be readily understood and appreciated by one skilled in the art that other methods of engaging the lid 30 with the top 15 or the base 20, such as a snap fit, could be used without deviating from the scope of the present invention.

In an embodiment, the opening 25 is sealed during the manufacturing process using a disposable cover (not shown), such as a thermo-closure seal adhered to the opening 25, to prevent unwanted contamination of the interior of the container 5 prior to use. In an alternative embodiment, the container 5 is sealed within a sterile enclosure (not shown), such as a plastic bag or shrink-wrap, during the manufacturing process. In an embodiment, a pull-tab (not shown) extends from the exterior of the sterile enclosure. When pulled, the pull-tab provides access to the interior of the sterile enclosure so that a user can access the container 5 for use. One skilled in the art would understand and appreciate that the container 5 could be sealed in other ways without deviating from the scope of the present invention.

In an embodiment, the lid 30 is engaged with the base 20 during the manufacturing process to prevent subsequent contamination of the lid 30 prior to use.

In an embodiment, a method of using the container 5 begins with removing the disposable cover (not shown) to allow access to the interior of the container 5. A sample 35 is then deposited into the container 5. Once the sample 35 has been collected, the lid 30 is disengaged from the base 20 and engaged with the top 15 to releasably seal the container 5 and prevent foreign matter from contaminating the sample 35.

In the preferred embodiment, the bulbous shape of the container 5 provides dual functionality. First of all, it mitigates, or prevents, splash-out during the collection of samples 35, most notably liquid samples such as urine. The inward tapering of the container's central portion 10 toward the opening 25 inhibits the splashed back liquid from escaping from the container 5. In addition to preventing splash-out, the container's shape provides a mechanism for sample preservation in the event the container 5 is tipped on its side prior to sealing the container 5. By having a wider central portion 10, the container 5 maintains a reservoir-like structure when turned on its side, such that a volume of liquid generally equal to the volume defined by the interior space below the lower edge of the lip, as defined when the container 5 is placed on its side, would be preserved in the event the container 5 is turned on its side.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A biological sample collection container comprising:
a. a base;
b. a top;
c. one or more walls extending upward from the base to the top; and
d. a lid configured to sealingly engage with the base or the top,
wherein the base and the one or more walls define a hollow central portion, wherein the top defines an aperture that extends into the central portion.

2. The biological sample collection container of claim 1, wherein an outer surface of the top and an outer surface of the base are threaded, and wherein an inner surface of the lid is correspondingly threaded, wherein the lid is configured to screw onto the top or the base.

3. The biological sample collection container of claim 1, wherein a recessed cavity extends upward into the base.

4. The biological sample collection container of claim 3, wherein an inner surface of the top and an inner surface of the base are threaded, and wherein an outer surface of the lid is correspondingly threaded, wherein the lid is configured to screw into the top or the base.

5. The biological sample collection container of claim 1, wherein a compressible material is adhered to an inner surface of the lid, wherein the compressible material is configured to sealingly engage with an outer surface of either the base or the top.

6. The biological sample collection container of claim 3, wherein a compressible material is adhered to an outer surface of the lid, wherein the compressible material is configured to sealingly engage with an inner surface of either the base or the top.

7. The biological sample collection container of claim 1, wherein the one or more walls extend outwardly from a perimeter of the base and the top.

8. The biological sample collection container of claim 1, wherein the one or more walls extend outwardly from a perimeter of the top.

9. The biological sample collection container of claim 1, wherein a shape of the container is selected from the group consisting of cylindrical, frustoconical, cubical, and bulbous.

10. The biological sample collection container of claim 1, further comprising a cover adhered to the top, wherein the cover is configured to be removed from the top to expose the aperture.

11. A method of using a biological sample collection container, comprising the steps of:
a. depositing a sample into the container;
b. removing a lid from a base of the container; and
c. engaging the lid with a top to releasably seal the container.

12. The method of claim 11, wherein prior to depositing the sample into the container, the method further comprises the step of removing a cover from the top of the container.

13. The method of claim 11, wherein prior to depositing the sample into the container, the method further comprises the step of removing the container from a sterile enclosure.
